(19) United States
(12) Patent Application Publication
(10) Pub. No.: US 2015/0300398 A1
(43) Pub. Date: Oct. 22, 2015

(54) ROTARY FASTENER

(71) Applicant: HANWIT PRECISION INDUSTRIES LTD., New Taipei City (TW)

(72) Inventor: Ying-Chih TSENG, New Taipei City (TW)

(21) Appl. No.: 14/570,793

(22) Filed: Dec. 15, 2014

Related U.S. Application Data
(63) Continuation-in-part of application No. 14/256,780, filed on Apr. 18, 2014, now Pat. No. 9,091,293.

(51) Int. Cl. F16B 39/24

(52) U.S. Cl. CPC F16B 39/24

(57) ABSTRACT

A rotary fastener includes a mounting base member including an inner barrel and an outer barrel fixedly fastened together, a fastening device including a spring-loaded pin member inserted through the mounting base member and a head member affixed to the pin member outside the mounting base member, an operating cap member fixedly mounted with the head member and rotatable relative to the mounting base member between an upper-limit position and a lower-limit position to move the pin member in and out of the bottom side of the mounting base member between a locking position and an unlocking position, and a guide track unit for guiding movement of the operating cap member relative to the mounting base member between the upper-limit position and the lower-limit position upon a rotary motion.

This application is a Continuation-In-Part of application Ser. No. 14/256,780, filed on Apr. 18, 2014, for which priority is claimed under 35 U.S.C. §120, the entire contents of which are hereby incorporated by reference.

### BACKGROUND OF THE INVENTION

1. Field of the Invention

The present invention relates to fastener means for detachably securing two panel members together and more particularly, to a rotary fastener, which comprises a mounting base member comprising an inner barrel and an outer barrel molded on the inner barrel by insert molding, a fastening device movably inserted through the mounting base member, and an operating device rotatable relative to the outer barrel of the mounting base member subject to the guidance of a guide track unit to move the fastening device in and out of the mounting base member between a locking position to lock the two panel members together and an unlocking position for allowing separation of the two panel members.

2. Description of the Related Art

Screws and pins are widely used in drawers, machines and many other retractable devices for temporarily locking a movable member to a fixed member in a predetermined operating position. Further, in a desk computer, notebook computer, industrial computer or workstation that consists of multiple devices or mechanisms, screws or pins may be used to detachably lock one first panel member to a second panel member. Unlocking these screws or pins allow separation of the first panel member and the second panel member.

However, mounting or dismounting the screws or pins, the users hand may easily be injured by the points or threads of the screws or pins. Further, the screws or pins can get lost easily after dismounting. If some screws or pins get lost, the assembled structure may be unstable. Further, a proper hand tool must be used when mounting or dismounting the screws or pins. If a proper hand tool is not available, the mounting or dismounting work will be interrupted, causing inconvenience.

In order to eliminate the aforesaid problems, rotary fasteners are created. FIGS. 10 and 11 illustrate a rotary fastener for use to lock panel members together. As illustrated, this design of rotary fastener comprises a mounting base member A, which comprises an axial through hole A0 extended from opposing top and bottom sides thereof and a recessed accommodation chamber A1 located in the top side, and a locking device B inserted through the axial through hole A0 of the mounting base member A. The locking device B comprises a locking pin B1, a compression spring B2, a position-limit member B3, and an operating knob B4. The locking pin B1 comprises a pin body B13, a bottom locking block B11 located at a bottom end of the pin body B13, a stop flange B12 extending around the periphery of the pin body B13 adjacent to the bottom locking block B11, a locating groove B15 extending around the periphery of the pin body B13 and spaced above the stop flange B12, two cut planes B14 bilaterally located at the periphery of the pin body B13, and a screw hole B16 located in an opposing top end of the pin body B13 remote from the bottom locking block B11. The compression spring B2 is sleeved onto the locking pin B1 and stopped between the stop flange B12 and the position-limit member B3. The position-limit member B3 is fixedly mounted in the recessed accommodation chamber A1 of the mounting base member A, comprising an oblong position-limit hole B30 cut through opposing top and bottom sides thereof and two cut planes B31 located in the oblong position-limit hole B30 and respectively abutted against the cut planes B14. The operating knob B4 is disposed above the mounting base member A, comprising a bottom screw rod B41 threaded into the screw hole B16 of the locking pin B1. The user can pull the operating knob B4 to lift the locking pin B1 and to compress the compression spring B2, enabling the bottom locking block B11 to be received in the axial through hole A0 inside the mounting base member A. When the locking pin B1 reaches the position where the locating groove B15 is kept in horizontal alignment with the position-limit member B3, the user can rotate the operating knob B4 and the locking pin B1 to move the two cut planes B14 of the locking pin B1 away from the two cut planes B31 of the position-limit member B3, enabling the pin body B13 of the locking pin B1 to be temporarily locked to the position-limit member B3 in the received (unlocking) position. When rotating the operating knob B4 relative to the position-limit member B3 and the mounting base member A to have the two cut planes B14 of the locking pin B1 face toward the two cut planes B31 of the position-limit member B3 and then release the force from operating knob B4, the compression spring B2 immediately pushes the locking pin B1 from the received (unlocking position) back to the extended (locking position) to suspend the bottom locking block B11 outside the axial through hole A0 of the mounting base member A.

According to the aforesaid prior art rotary fastener, the position-limit member B3 is fixedly mounted in the recessed accommodation chamber A1 of the mounting base member A, thus, the user cannot easily view the relative positions between the two cut planes B14 of the locking pin B1 and the two cut planes B31 of the position-limit member B3, making the operation difficult. Further, when pulling the operating knob B4 to lift the locking pin B1 relative to the position-limit member B3 and the mounting base member A, the compression spring B2 imparts a resistance to the operating knob B4, causing the user unable to keep the locking pin B1 in balance, and the locking pin B1 can be accidentally forced by the compression spring B2 toward the outside of the axial through hole A0 of the mounting base member A, causing the operating knob B4 to strike against the position-limit member B3 and the mounting base member A. Therefore, there is a strong demand for a rotary fastener that eliminates the drawbacks of the aforesaid prior art design.

### SUMMARY OF THE INVENTION

The present invention has been accomplished under the circumstances in view. It is therefore the main object of the present invention to provide a rotary fastener for locking two panel members together through a rotary motion, which has the advantages of ease of use, high installation reliability and high positioning accuracy.

To achieve this and other objects of the present invention, the rotary fastener comprises a mounting base member, a fastening device, which comprises a pin member vertically upwardly inserted through the mounting base member, a head member fastened to the top end of the pin member and disposed above the mounting base member and an elastic member mounted around the pin member and stopped between an expanded bottom engagement portion at the bottom end of the pin member and a part inside the mounting base member, an operating cap member fixedly mounted with the head member outside the mounting base member and rotatable relative to the mounting base member between an upper-limit position and a lower-limit position to move the pin member in and out of the bottom side of the mounting base member between a locking position and an unlocking position, and a guide track unit located at the bottom side of the operating cap member and the top side of the mounting base member for guiding movement of the operating cap member relative to the mounting base member between the upper-limit position and the lower-limit position upon a rotary motion.

Preferably, the mounting base member comprises an inner barrel, and an outer barrel molded on the inner barrel by insert molding. Further, the inner barrel comprises an engagement structure located at the periphery thereof for engagement with an inside wall of the outer barrel. Further, the engagement structure comprises a plurality of grooves and a plurality of ribs alternatively spaced around the periphery of the inner barrel. In one embodiment, the engagement structure comprises a plurality of longitudinal grooves and a plurality of longitudinal ribs alternatively spaced around the periphery of the inner barrel. In another embodiment, the engagement structure comprises a plurality of crossed grooves and a plurality of crossed ribs alternatively spaced around the periphery of the inner barrel.

Preferably, the guide track unit comprises a plurality of high-position locating surface portions equiangularly spaced on the top side of the outer barrel, a plurality of homing surface portions located at the top side of the outer barrel at a relatively lower elevation than the high-position locating surface portions and respectively spaced between each two adjacent high-position locating surface portions, a plurality of positioning surface portions equiangularly spaced on the bottom side of the operating cap member and movable with the operating cap member between the upper-limit position where the positioning surface portions are respectively positioned on the high-position locating surface portions and the lower-limit position where the positioning surface portions are respectively positioned on the homing surface portions, a plurality of first sloping guide paths located at the top side of the outer barrel and respectively connected between respective one ends of the high-position locating surface portions and respective one ends of the homing surface portions, a plurality of high-position stop surface portions located at the top side of the outer barrel and respectively upwardly extended from respective opposing ends of the high-position locating surface portions, a plurality of upright stop surface portions located at the top side of the outer barrel and respectively upwardly extended from respective opposing ends of the homing surface portions, a plurality of position-limit grooves located at the top side of the outer barrel and respectively connected between the upright stop surface portions and the homing surface portions, a plurality of second sloping guide paths located at the bottom side of the operating cap member and respectively extended from respective one ends of the positioning surface portions and configured to fit the first sloping guide paths, a plurality of upright abutment surface portions located at the bottom side of the operating cap member for abutment against the upright stop surface portions respectively, and a plurality of abutment protrusions respectively connected between the positioning surface portions and the upright abutment surface portions for engaging the position-limit grooves respectively.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a rotary fastener in accordance with the present invention.

FIG. 2 is an exploded view of the rotary fastener in accordance with the present invention.

FIG. 3 corresponds to FIG. 2 when viewed from another angle.

FIG. 4 is a sectional applied view of the present invention, illustrating the mounting base member affixed to a first panel member and the expanded bottom engagement portion of the pin member of the fastening device fastened to a second panel member.

FIG. 5 is a schematic elevational operational view of the present invention, illustrating the operating cap member rotated relative to the mounting base member and the positioning surface portions respectively moved out of the respective homing surface portion to the respective first sloping guide paths.

FIG. 6 corresponds to FIG. 5, illustrating the positioning surface portions respectively moved away from the respective first sloping guide paths and reached the respective high-position locating surface portions.

FIG. 7 is a schematic sectional view of the present invention, illustrating the operating cap member in the upper-limit position and the fastening device disengaged from the locking hole of the second panel member and received in the mounting base member in the unlocking position.

FIG. 8 is an oblique top elevational view of an alternate form of the rotary fastener in accordance with the present invention.

FIG. 9 is an oblique top elevational view of another alternate form of the rotary fastener in accordance with the present invention.

FIG. 10 is an exploded view of a rotary fastener according to the prior art.

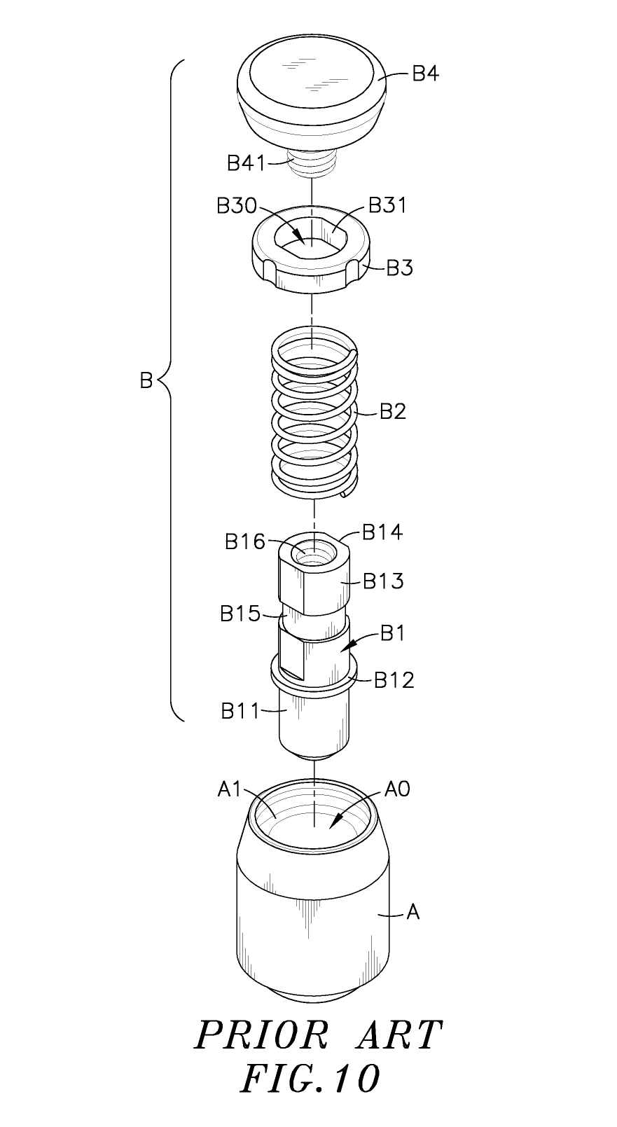

FIG. 11 is a schematic sectional applied view of the prior art rotary fastener.

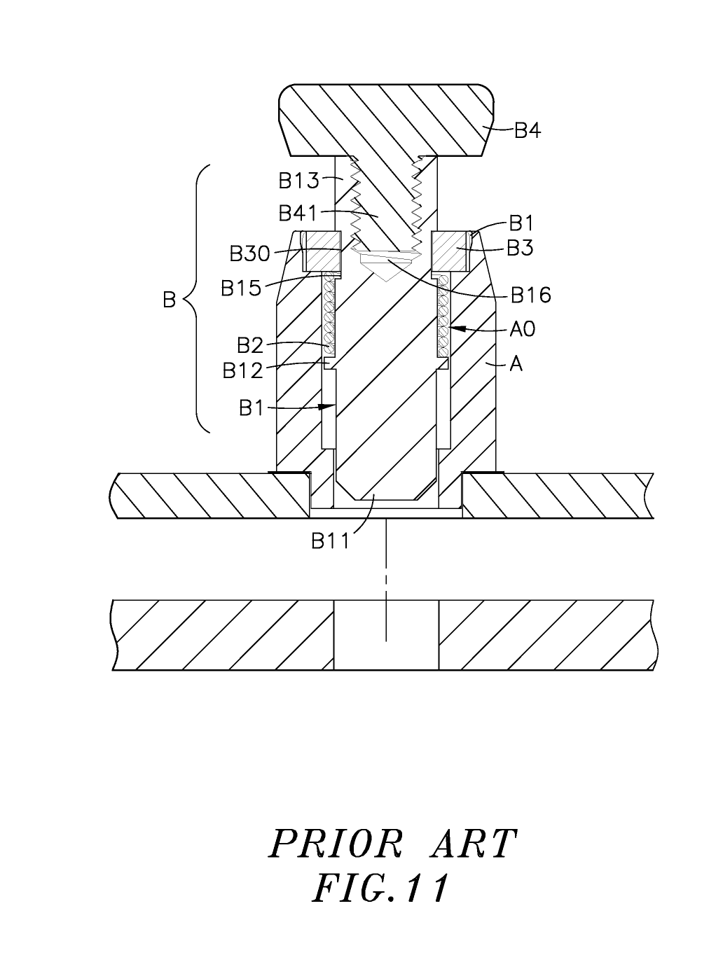

### DETAILED DESCRIPTION OF THE PREFERRED EMBODIMENT

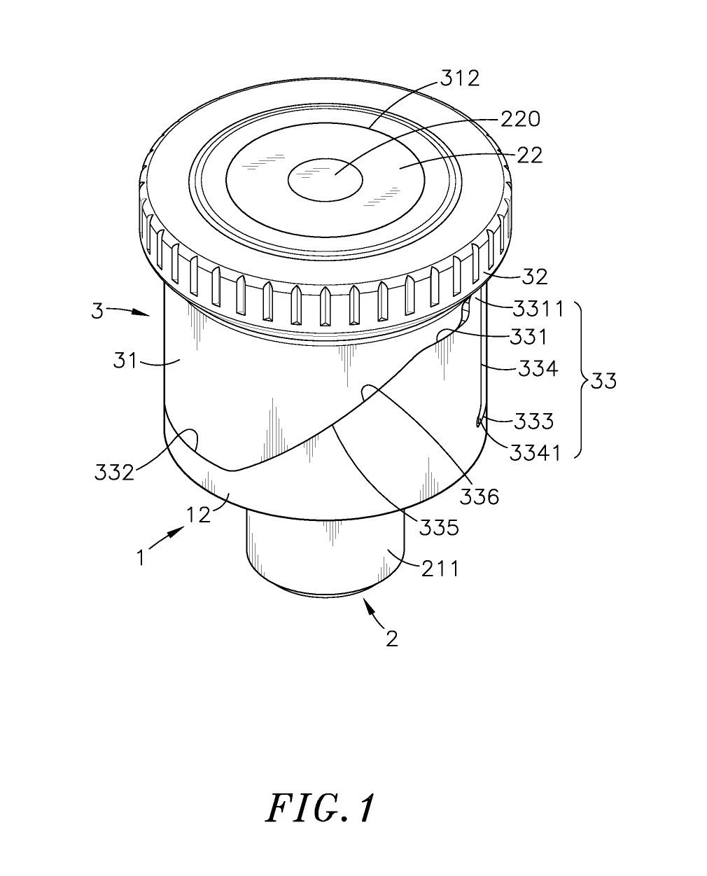

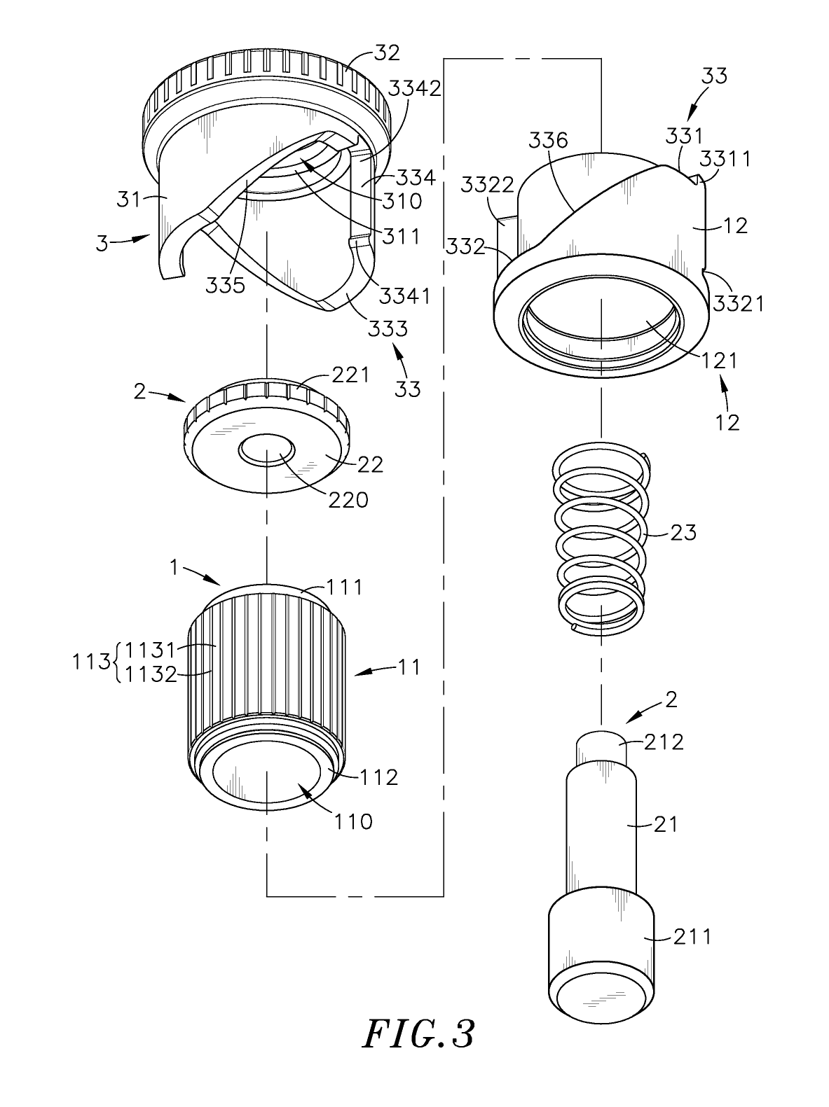

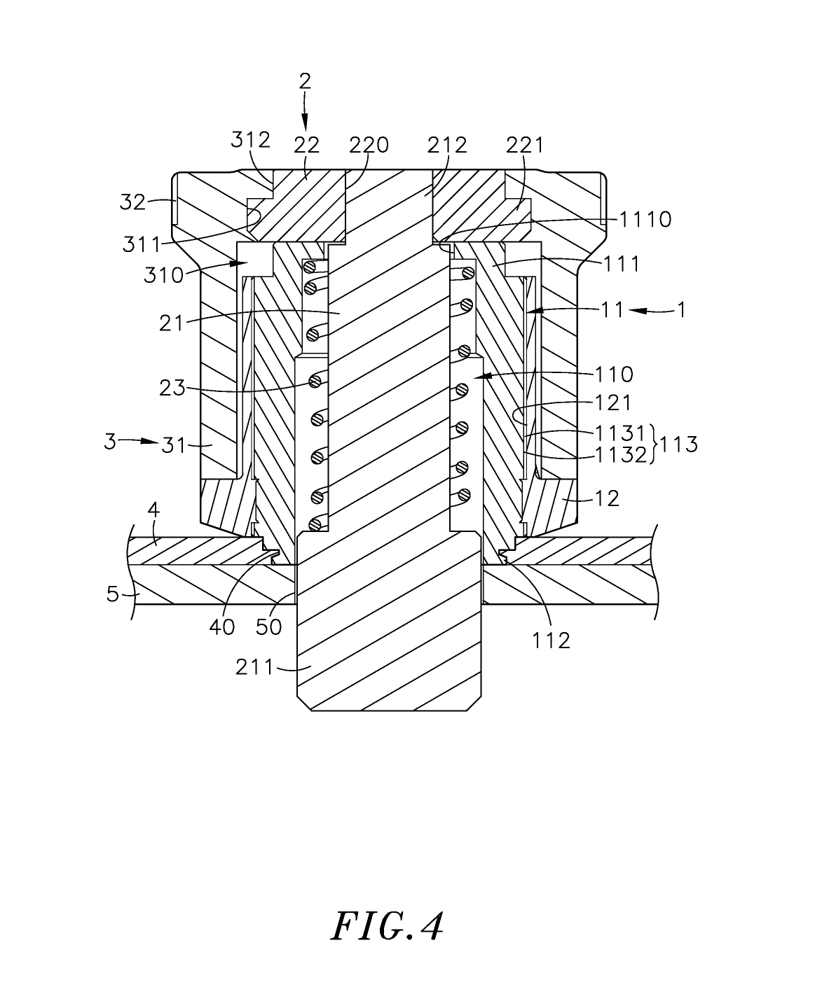

Referring to FIGS. 1-4, a rotary fastener in accordance with the present invention is shown. The rotary fastener comprises a mounting base member 1, a fastening device 2, and an operating device 3.

The mounting base member 1 comprises an inner barrel 11, and an outer barrel 12 affixed to the inner barrel 11 on the outside. The inner barrel 11 comprises an accommodation chamber 110 defined therein and extending through a bottom side thereof, a top neck 111 upwardly extending from an opposing top side thereof, a bottom mounting neck 112 located at the bottom side thereof around a bottom side of the accommodation chamber 110, an axle hole 1110 defined in the top neck 11 in communication between the accommodation chamber 110 and the space outside of the inner barrel 11 and having a diameter smaller than the diameter of the accommodation chamber 110, and an engagement structure 113 formed integral with the periphery thereof for engagement with an inside wall 121 of the outer barrel 12.

The fastening device 2 comprises a pin member 21, a head member 22, and an elastic member, for example, compression spring 23. The pin member 21 comprises an expanded bottom engagement portion 211 located at a bottom end thereof, and a mounting tip 212 reduced in diameter and located at an opposing top end thereof. The head member 22 comprises a center mounting hole 220 fixedly fastened to the mounting tip 212 of the pin member 21, and an engagement wall 221 extending around the periphery thereof. The compression spring 23 is sleeved onto the pin member 21 and supported on the expanded bottom engagement portion 211.

The operating device 3 comprises an operating cap member 31, a grip 32, and a guide track unit 33. The operating cap member 31 comprises a bottom-open chamber 310, a locating groove 311 located on an inside wall thereof and extending around a top side of the bottom-open chamber 310 and adapted for receiving the engagement wall 221 of the head member 22, and a top opening 312 axially cut through a top wall thereof in communication with the locating groove 311 and the bottom-open chamber 310. The grip 32 is formed integral with the periphery of the operating cap member 31. The guide track unit 33 is located at a bottom side of the operating cap member 31 and a top side of the outer barrel 12 of the mounting base member 1 to guide relative rotary motion between the operating cap member 31 and the top side of the outer barrel 12.

When assembling the rotary fastener, affix the outer barrel 12 of the mounting base member 1 to the inner barrel 11, and then fixedly fasten the engagement wall 221 of the head member 22 of the fastening device 2 to the locating groove 311 in the bottom-open chamber 310 of the operating cap member 31 of the operating device 3, and the upwardly insert the pin member 21 through the compression spring 23 and the accommodation chamber 110 and axle hole 1110 of the inner barrel 11 of the mounting base member 1 to tightly fasten the mounting tip 212 of the pin member 21 to the center mounting hole 220 of the head member 22, allowing the compression spring 23 to be stopped between the expanded bottom engagement portion 211 of the pin member 21 and an inside wall of the inner barrel 11 adjacent to the axle hole 1110. When assembled, the outer barrel 12 of the mounting base member 1 is received in the bottom-open chamber 310 of the operating cap member 31.

The guide track unit 33 comprises two high-position locating surface portions 331 symmetrically located at the top side of the outer barrel 12 at two opposing locations, two homing surface portions 332 located at the top side of the outer barrel 12 and bilaterally equally spaced between the high-position locating surface portions 331 at a relatively lower elevation, two first sloping guide paths 336 located at the top side of the outer barrel 12 and respectively connected between respective one ends of the high-position locating surface portions 331 and respective one ends of the homing surface portions 332, two high-position stop surface portions 3311 located at the top side of the outer barrel 12 and respectively upwardly extended from respective opposing ends of the high-position locating surface portions 331 remote from the first sloping guide paths 336 and the homing surface portions 332, two upright stop surface portions 3322 located at the top side of the outer barrel 12 and respectively upwardly extended from respective one ends of the homing surface portions 332 remote from the first sloping guide paths 336, two position-limit grooves 3321 located at the top side of the outer barrel 12 and respectively connected between the upright stop surface portions 3322 and the homing surface portions 332, two positioning surface portions 333 symmetrically located at the bottom side of the operating cap member 32 at two opposing locations for abutment against the homing surface portions 332 at the outer barrel 12, two second sloping guide paths 335 located at the bottom side of the operating cap member 31 and respectively extended from respective one ends of the positioning surface portions 333 and configured to fit the first sloping guide paths 336 at the top side of the outer barrel 12, and two abutment structures 334 located at the bottom side of the operating cap member 31 and respectively extended from respective opposing ends of the positioning surface portions 333. Each abutment structure 334 comprises an abutment protrusion 3341 for engaging one respective position-limit groove 3321 at the outer barrel 12, and an upright abutment surface portion 3342 for abutment against one respective upright stop surface portions 3322 at the outer barrel 12. Subject to the functioning of the guide track unit 33, the operating cap member 31 can be rotatably moved relative to the outer barrel 12 between a lower-limit position, i.e., the locking position where the expanded bottom engagement portion 211 of the pin member 21 is extended out of the bottom side of the inner barrel 11, and a upper-limit position, i.e., the unlocking position where the expanded bottom engagement portion 211 of the pin member 21 is received in the accommodation chamber 110 inside the inner barrel 11.

Further, the outer barrel 12 of the mounting base member 1 can be directly molded on the inner barrel 11 using insert molding technology. During the insert molding process, the top neck 111 of the inner barrel 11 is secured in place by clamping means of the mold, prohibiting the molten fluid from flowing through the axle hole 1110 into the inside of the inner barrel 11. Thus, the molded mounting base member 1 can be conveniently assembled with the pin member 21 and head member 22 of the fastening device 2.

Further, in this embodiment, the guide track unit 33 of the operating device 3 comprises two high-position locating surface portions 331, two homing surface portions 332 and two positioning surface portions 333, wherein the high-position locating surface portions 331, homing surface portions 332 or positioning surface portions 333 are spaced from each other at 180°. However, this design is not a limitation. In an alternate form of the present invention, the guide track unit 33 of the operating device 3 can be configured to provide four high-position locating surface portions 331, four homing surface portions 332 and four positioning surface portions 333, wherein the high-position locating surface portions 331, homing surface portions 332 or positioning surface portions 333 are spaced from one another at 90°.

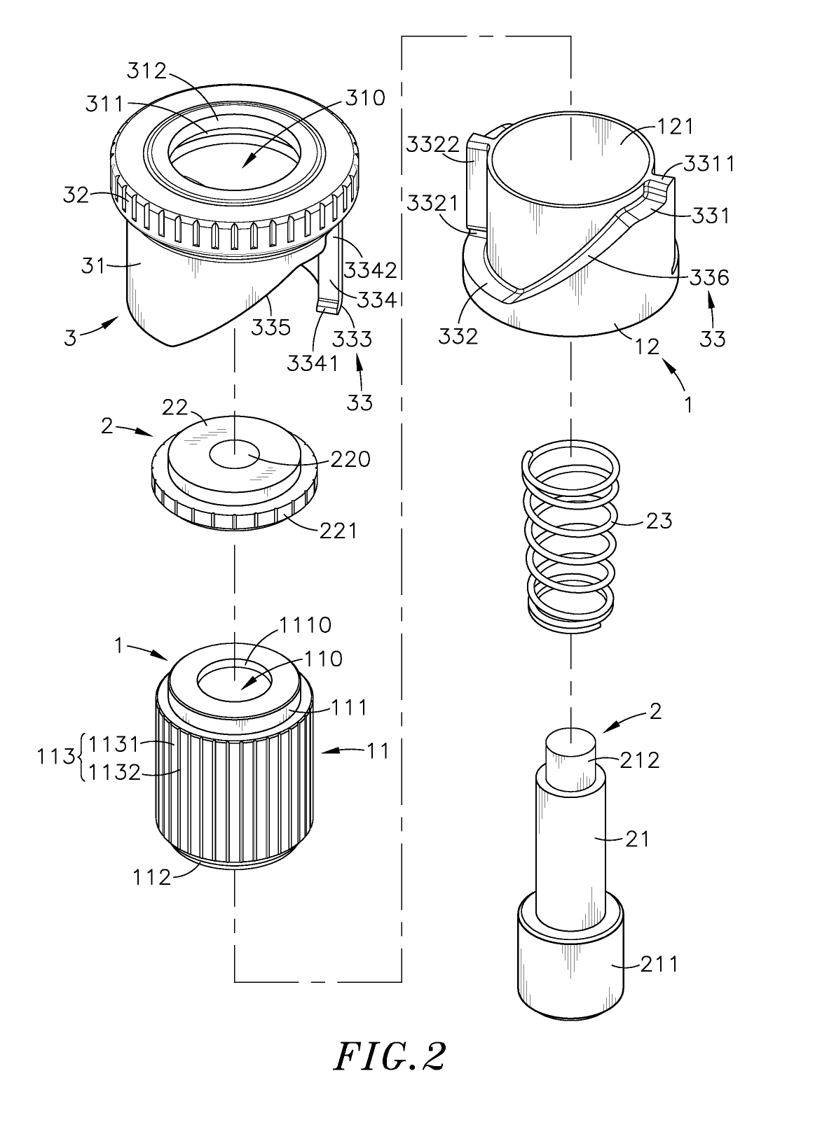

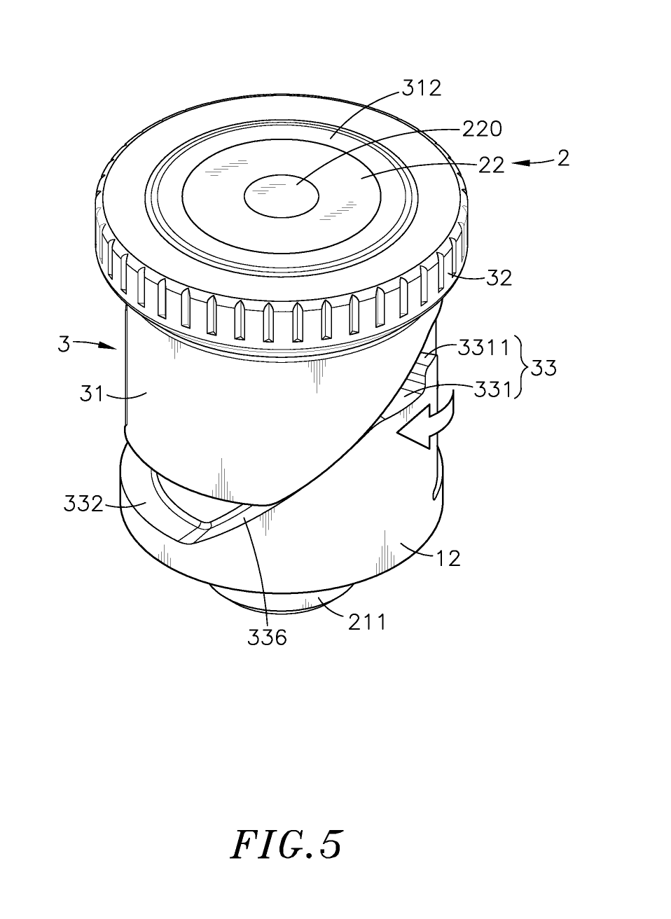

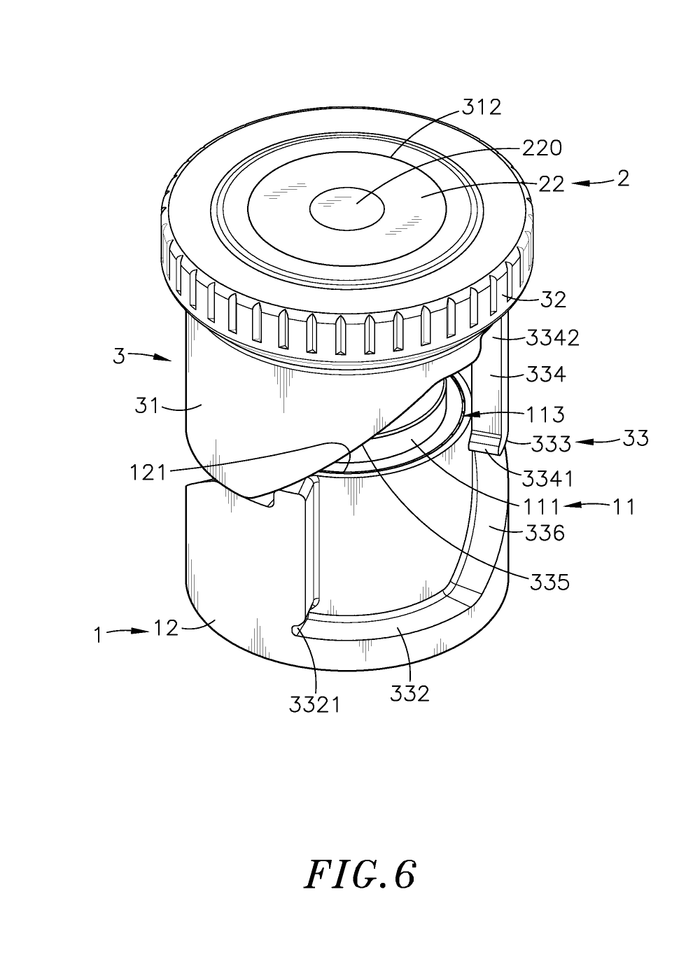

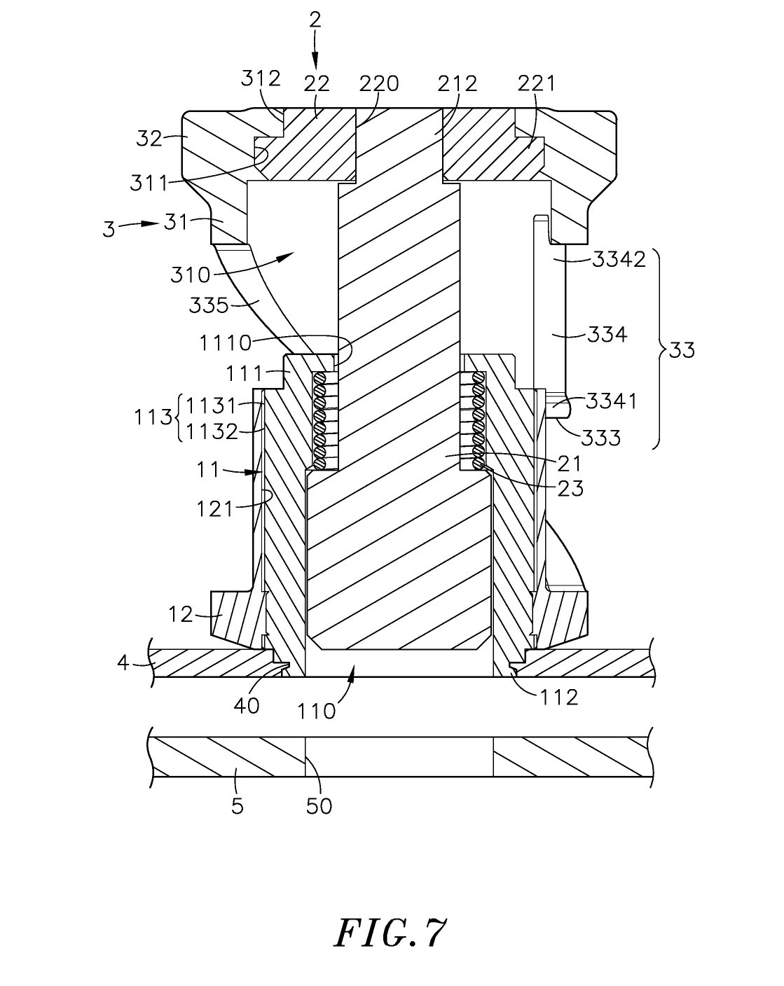

Referring to FIGS. 5-7 and FIGS. 2 and 4 again, the user can hold the grip 32 to rotate the operating cap member 31 of the operating device 3 relative to the mounting base member 1 in one direction through 90° from the lower-limit position, to the upper-limit position, causing the positioning surface portions 333 to be moved with the operating cap member 31 away from the respective homing surface portions 332 along the respective first sloping guide paths 336 at the outer barrel 12 to the respective high-position locating surface portions 331 and then stopped at the respective high-position stop surface portions 3311. When rotating the operating cap member 31, the pin member 21 of the fastening device 2 is moved with the head member 22 and the operating cap member 31 from the locking position, where the expanded bottom engagement portion 211 of the pin member 21 is extended out of the bottom side of the inner barrel 11, to the unlocking position, where the expanded bottom engagement portion 211 of the pin member 21 is received in the accommodation chamber 110 inside the inner barrel 11. When the pin member 21 reaches to the unlocking position, the compression spring 23 is compressed. Subject to the guidance of the guide track unit 33, the pin member 21 of the fastening device 2 is moved smoothly between the locking position and the unlocking position without vibration, and no significant resisting force will be produced between the outer barrel 12 and the operating cap member 31.

When holding the grip 32 to rotate the operating cap member 31 of the operating device 3 relative to the mounting base member 1 in the reversed direction through 90° from the upper-limit position to the lower-limit position, the positioning surface portions 333 will be moved with the operating cap member 31 away from the respective high-position locating surface portions 331 along the respective first sloping guide paths 336 at the outer barrel 12 to the respective homing surface portions 332, causing the respective abutment protrusions 3341 to be engaged into the respective position-limit grooves 3321. At this time, the positioning surface portions 333 are respectively supported on the homing surface portions 332, the second sloping guide paths 335 are respectively abutted against the first sloping guide paths 336, and the upright abutment surface portions 3342 are respectively abutted against the respective upright stop surface portions 3322, and thus the operating cap member 31 is positively held on the outer barrel 12 of the mounting base member 1 in the lower-limit position. When the operating cap member 31 of the operating device 3 reaches the lower-limit position, the pin member 21 of the fastening device 2 is moved to the locking position to suspend the expanded bottom engagement portion 211 outside the accommodation chamber 110 of the inner barrel 11.

Further, the bottom mounting neck 112 of the inner barrel 11 of the mounting base member 1 suspends outside the bottom side of the outer barrel 12. In application, affix the bottom mounting neck 112 of the inner barrel 11 of the rotary fastener to a mounting through hole 40 of a first panel member 4. At this time, the user can attach the first panel member 4 to a second panel member 5, and then operate the rotary fastener to lock the first panel member 4 to the second panel member 5 by rotating the operating cap member 31 to move the pin member 21 from the unlocking position to the locking position to engage the expanded bottom engagement portion 211 of the pin member 21 into a locking hole 50 in the second panel member 5. When rotating the operating cap member 31 in the reversed direction from the lower-limit position to the upper-limit position, the pin member 21 will be moved with the operating cap member 31 from the locking position to the unlocking position to disengage the expanded bottom engagement portion 211 of the pin member 21 from the locking hole 50 of the second panel member 5, allowing separation between the first panel member 4 and the second panel member 5.

Further, the grip 32 can be configured comprising a plurality of grooves and/or ribs spaced around the periphery of the operating cap member 31. Alternatively, the grip 32 can be a rod member or wing member outwardly extended from the periphery of the operating cap member 31 for operation by a user to rotate the operating cap member 31 relative to the outer barrel 12 of the mounting base member 1 with less effort.

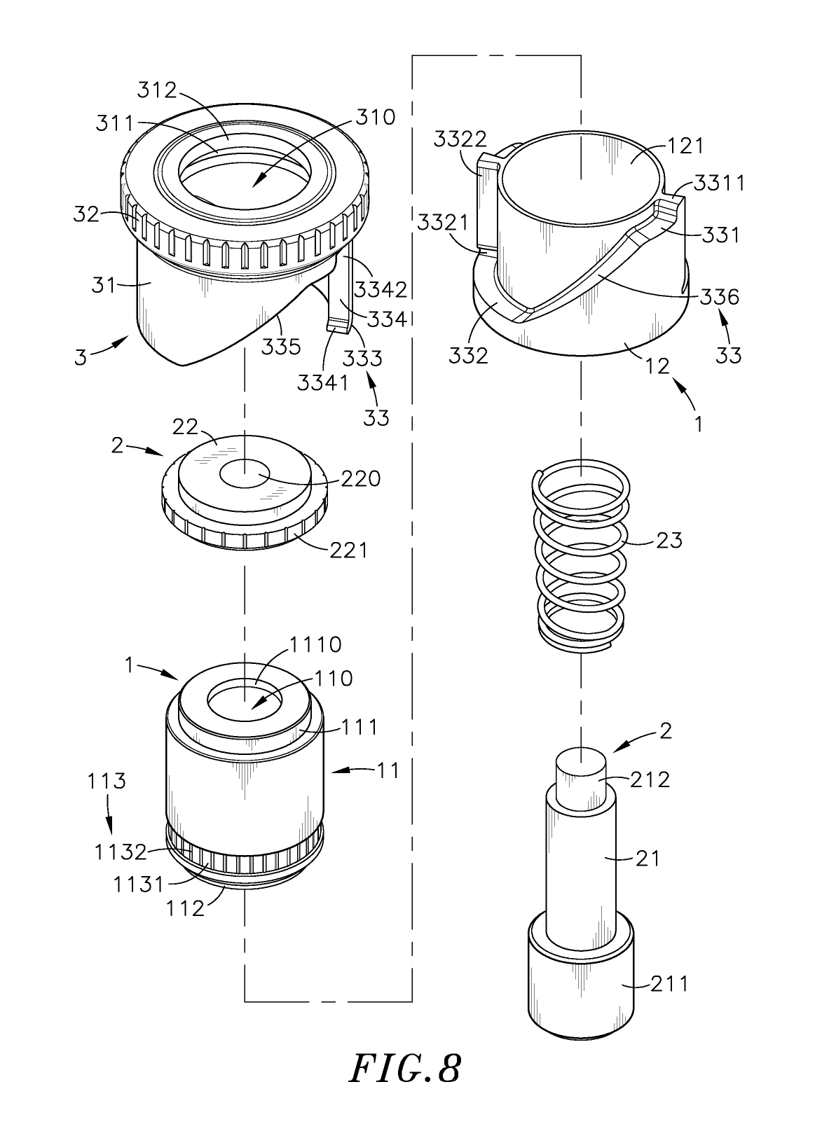

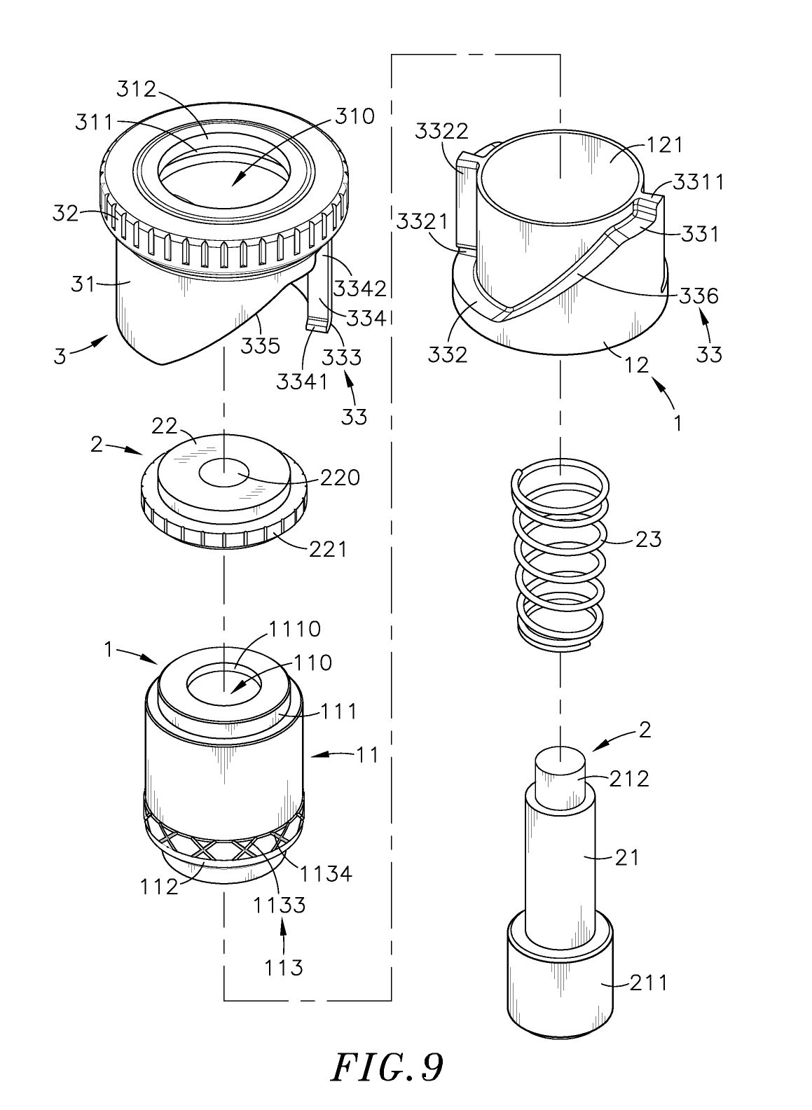

Further, in the embodiment shown in FIG. 2, the engagement structure 113 comprises a plurality of longitudinal ribs 1131 and longitudinal grooves 1132 alternatively spaced around the periphery of the inner barrel 11 for engagement with the inside wall 121 of the outer barrel 12. In this embodiment, the engagement structure 113 covers the whole surface area of the periphery of the inner barrel 11. In an alternate form of the present invention as shown in FIG. 8, the engagement structure 113 covers only a small lower part of the periphery of the inner barrel 11. In another form of the present invention as shown in FIG. 9, the engagement structure 113 comprises a plurality of crossed ribs 1133 and crossed grooves 1134 alternatively spaced around the periphery of the inner barrel 11 for engagement with the inside wall 121 of the outer barrel 12. In this embodiment, the engagement structure 113 covers only a small lower part of the periphery of the inner barrel 11. When molding the outer barrel 12 on the inner barrel 11 by using insert molding technology, the engagement structure 113 enhances the connection tightness between the inside wall 121 of the outer barrel 12 and the periphery of the inner barrel 11.

In conclusion, the invention provides a rotary fastener mountable at a first panel member for detachably locking the first panel member to a second panel member through a rotary operation. The rotary fastener comprises a mounting base member 1, which comprises an inner barrel 11 defining therein an accommodation chamber 110 and an outer barrel 12 molded on the inner barrel 11 by insert molding, a fastening device 2, which comprises a pin member 21 inserted through the accommodation chamber 110 of the inner barrel 11 and having a mounting tip 212 located at a top end thereof and suspending outside the mounting base member 1 and an expanded bottom engagement portion 211 located at an opposing bottom end thereof, a head member 22 fixedly fastened to the mounting tip 212 of the pin member 21 outside the mounting base member 1 and an elastic member 23 mounted around the pin member 21 and stopped between the expanded bottom engagement portion 211 of the pin member 21 and a part of the inner barrel 11 in the accommodation chamber 110, and an operating device 3, which comprises an operating cap member 31 affixed to the head member 22 of the fastening device 2 and rotatable relative to the mounting base member 1 to move between an upper-limit position and a lower-limit position to further carry the pin member 21 of the fastening device 2 between an unlocking position where the expanded bottom engagement portion 211 of the pin member 21 is received inside the accommodation chamber 110 of the inner barrel 11 and a locking position where the expanded bottom engagement portion 211 of the pin member 21 is extended out of the accommodation chamber 110 of the inner barrel 11, and a guide track unit 33 located at the bottom side of the operating cap member 31 and the top side of the outer barrel 12 for guiding the operating cap member 31 to move between the upper-limit position and the lower-limit position upon a rotary motion. Subject to the guidance of the guide track unit 33, the operating cap member 31 can be smoothly and accurately rotated between the upper-limit position and the lower-limit position without causing component impact.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A rotary fastener installed in a mounting through hole of a first panel member and adapted for detachably locking said first panel member to a locking hole of a second panel member, the rotary fastener comprising:
a mounting base member comprising an inner barrel and an outer barrel molded on said inner barrel by insert molding, said inner barrel comprising an accommodation chamber defined therein, a top neck located at a top side thereof and upwardly extended out of said outer barrel and a bottom mounting neck located at an opposing bottom side thereof and affixed to said mounting through hole of said first panel member;
a fastening device, said fastening device comprising a head member disposed outside said mounting base member, a pin member having a top end thereof upwardly inserted through said accommodation chamber of said inner barrel of said mounting base member and fixedly connected to said head member and an opposing bottom end thereof terminating in an expanded bottom engagement portion that is adapted for engaging into said locking hole of said second panel member to lock said second panel member to said first panel member, and an elastic member mounted around said pin member and stopped between said expanded bottom engagement portion of said pin member and a part of said inner barrel in said accommodation chamber;
an operating device, said operating device comprising an operating cap member fixedly mounted with said head member of said fastening device and supported on said outer barrel of said mounting base member and rotatable by an external force relative to said outer barrel between a lower-limit position and an upper-limit position to move said pin member between a locking position where said expanded bottom engagement portion of said pin member is engaged into said locking hole of said second panel member to lock said second panel member to said first panel member and an unlocking position where said expanded bottom engagement portion of said pin member is disengaged from said locking hole of said second panel member and received inside said accommodation chamber of said inner barrel for allowing separation between said first panel member and said second panel member; and
a guide track unit located at a bottom side of said operating cap member and a top side of said outer barrel of said mounting base member and adapted for guiding said operating cap member to move relative to said outer barrel of said mounting base member between said upper-limit position and said lower-limit position through a rotary motion.

2. The rotary fastener as claimed in claim 1, wherein said inner barrel comprises an engagement structure extending around the whole area of the periphery thereof for engagement with an inside wall of said outer barrel, said engagement structure comprising a plurality of grooves and ribs alternatively spaced around the periphery of said inner barrel.

3. The rotary fastener as claimed in claim 1, wherein said inner barrel comprises an engagement structure extending around at least one segment of the periphery thereof for engagement with an inside wall of said outer barrel, said engagement structure comprising a plurality of grooves and ribs alternatively spaced around the periphery of said inner barrel.

4. The rotary fastener as claimed in claim 1, wherein said pin member comprises a mounting tip located at the top end thereof; said head member comprises a center mounting hole fixedly fastened to said mounting tip of said pin member, and an engagement wall extending around the periphery thereof; said operating cap member comprises a locating groove located on an inside wall thereof and fixedly fastened to said engagement wall of said head member.

5. The rotary fastener as claimed in claim 1, wherein said guide track unit comprises a plurality of high-position locating surface portions equiangularly spaced on the top side of said outer barrel, a plurality of homing surface portions located at the top side of said outer barrel at a relatively lower elevation than said high-position locating surface portions and respectively spaced between each two adjacent said high-position locating surface portions, and a plurality of positioning surface portions equiangularly spaced on the bottom side of said operating cap member and movable with said operating cap member between said upper-limit position where said positioning surface portions are respectively positioned on said high-position locating surface portions and said lower-limit position where said positioning surface portions are respectively positioned on said homing surface portions.

6. The rotary fastener as claimed in claim 5, wherein the number of said high-position locating surface portions is 2, and these two said high-position locating surface portions are spaced from each other at 180°; the number of said homing surface portions is 2, and these two said homing surface portions are spaced from each other at 180°; the number of said positioning surface portions is 2, and these two said positioning surface portions are spaced from each other at 180°.

7. The rotary fastener as claimed in claim 5, wherein the number of said high-position locating surface portions is 4, and these four said high-position locating surface portions are spaced from each other at 90°; the number of said homing surface portions is 4, and these four said homing surface portions are spaced from each other at 90°; the number of said positioning surface portions is 4, and these four said positioning surface portions are spaced from each other at 90°.

8. The rotary fastener as claimed in claim 5, wherein said guide track unit further comprises a plurality of first sloping guide paths located at the top side of said outer barrel and respectively connected between respective one ends of said high-position locating surface portions and respective one ends of said homing surface portions, a plurality of high-position stop surface portions located at the top side of said outer barrel and respectively upwardly extended from respective opposing ends of said high-position locating surface portions, a plurality of upright stop surface portions located at the top side of said outer barrel and respectively upwardly extended from respective opposing ends of said homing surface portions, and a plurality of position-limit grooves located at the top side of said outer barrel and respectively connected between said upright stop surface portions and said homing surface portions.

9. The rotary fastener as claimed in claim 8, wherein said guide track unit further comprises a plurality of second sloping guide paths located at the bottom side of said operating cap member and respectively extended from respective one ends of said positioning surface portions and configured to fit said first sloping guide paths, a plurality of upright abutment surface portions located at the bottom side of said operating cap member for abutment against said upright stop surface portions respectively, and a plurality of abutment protrusions respectively connected between said positioning surface portions and said upright abutment surface portions for engaging said position-limit grooves respectively.

10. The rotary fastener as claimed in claim 1, wherein said operating device further comprises a grip formed integral with the periphery of said operating cap member.

11. The rotary fastener as claimed in claim 10, wherein said grip comprises a plurality of grooves and ribs alternatively spaced around the periphery of said operating cap member.

12. The rotary fastener as claimed in claim 10, wherein said grip comprises at least one wing member outwardly extended the periphery of said operating cap member.
